(19) United States
(12) Patent Application Publication
(10) Pub. No.: US 2026/0266603 A1
(43) Pub. Date: Sep. 10, 2026

(54) METHOD FOR DETERMINING FEATURE CHARACTERISTICS OF A SURFACE

(71) Applicant: Dätwyler Schweiz AG, Schattdorf (CH)

(72) Inventors: Yassine AHAGGACH, Zurich (CH); Samira JAFARI, Zurich (CH); Markus IMHOF, Bürglen (CH); Yassine LAMKHARBECH, Altdorf (CH); Morteza NEJATI, Zurich (CH)

(73) Assignee: Dätwyler Schweiz AG, Schattdorf (CH)

(21) Appl. No.: 19/165,631

(22) PCT Filed: Feb. 20, 2024
(86) PCT No.: PCT/CH2024/050008

§ 371 Date: Sep. 16, 2025

(30) Foreign Application Priority Data
Mar. 16, 2023 (CH) 000294/2023

(51) Int. Cl. G01C 7/04

(52) U.S. Cl. CPC G01C 7/04

(57) ABSTRACT

A method for determining feature characteristics of a surface includes: equipping a mobile wheeled machine with at least one measurement wheel which has at least one film-based sensor stripe covered by a rubber layer on a radially outer side of the at least one film-based sensor stripe, a movement sensing device, and a transmitter for data transmission from the at least one film-based sensor stripe and the movement sensing device; driving the mobile wheeled machine over the surface; transmitting measurement data measured by the at least one film-based sensor stripe and movement sensing data gathered by the movement sensing device to a computer hardware using the transmitter; and receiving the transmitted measurement and sensing data and processing it with a sequence of one or more software modules installed on the computer hardware. The sequence of one or more software modules determines the feature characteristics from its input.

### TECHNICAL FIELD

The invention relates to a method for determining feature characteristics of a surface.

### TECHNICAL BACKGROUND

It is often of interest how a mobile wheeled machine interacts with the surface it is moving on. Such information on the one hand can help to improve the mechanics of the machine and to understand how to optimally react to different conditions in order to achieve a set and/or application driven goal like maximum speed, stability, or sustainability. On the other hand it can provide insights about the surface which go beyond what is tangible by means of contactless and/or pointwise and/or static measurements, as well as by means of inspection by human senses. In the context of the exploration of unknown ground for example, even both aspects can be relevant.

The existing technology however does not provide a way to acquire information suitable for the above aims.

### SUMMARY OF THE INVENTION

It is an objective of the invention to provide a method which is suitable for the above aims.

At least one of the objectives of the present invention is achieved by a method for determining feature characteristics of a surface according to claim 1.

The method for determining feature characteristics of a surface comprises the following steps: (a) a mobile wheeled machine, preferably a vehicle, a hand-held device, or a robot, is equipped with (i) at least one measurement wheel, where the at least one measurement wheel comprises at least one film-based sensor stripe which is arranged in such a way that it circles the at least one measurement wheel with respect to the axis of rotation of the at least one measurement wheel, and where the at least one film-based sensor stripe is covered by a rubber layer on a radially outer side of the at least one film-based sensor stripe, (ii) a movement sensing device, and (iii) means for data transmission from the at least one film-based sensor stripe and the movement sensing device; (b) the mobile wheeled machine is driven over the surface; (c) measurement data measured by the at least one film-based sensor stripe and movement sensing data gathered by the movement sensing device are transmitted to a computer hardware using the means for data transmission, where the computer hardware is equipped with means for data reception; and (d) on the computer hardware (i) the transmitted measurement data and the transmitted movement sensing data are received using the means for data reception, and (ii) the received measurement data and the received movement sensing data are processed by means of a sequence of one or more software modules installed on the computer hardware, where at least one module of the sequence of one or more software modules is configured to determine the feature characteristics from its input.

The presented method is eligible for determining the feature characteristics of the surface. Hereby the surface itself and its properties may be of interest. For example, when treating a surface, e.g., by applying an additional layer, the feature characteristics may allow to monitor and, if necessary, adapt the treatment process. Alternatively, one may for example use the feature characteristics and/or information gained from it in order to optimize the movement and/or behavior of the mobile wheeled machine, in terms of mechanics and/or control, and/or to automatize its movement, for example in the sense that the machine can react automatically to obstacles. When exploring an unknown terrain, both mentioned applications can be relevant. Further applications and combinations of applications are possible.

The feature characteristics of the surface is understood here as a set of identical feature variables, where each feature variable represents the feature and is assigned to a unique point from a set of points describing the surface.

The set of points describing the surface may be defined before the start of the method or generated and/or adapted during the execution of the method. Similarly, the set of feature variables constituting the feature characteristics and therewith the feature characteristics itself may be defined before the start of the method or generated and/or adapted during the execution of the method. The determination of the feature characteristics is understood here as the process of determining the feature variables of the set of identical feature variables constituting the feature characteristics. The determined feature characteristics at some point in time is the set of the at this time determined feature variables of the set of identical feature variables constituting the feature characteristics.

The feature can correspond to a quantity which is directly measured by the at least one film-based sensor stripe, or a quantity which is computed from the measurement data measured by the at least one film-based sensor stripe and possibly additional input data.

The possible choices for the feature are not limited to the examples presented here, but only possibly by the data which can be measured by means of the at least one measurement wheel. The optimal number and arrangement of the at least one measurement wheel and/or the at least one film-based sensor stripe and/or the choice of the movement sensing device may differ for different choices of the feature. Also, for some choices of the feature, some choices for the set of points describing the surface may be more appropriate than others.

The points within the set of points describing the surface can correspond to actual points on the surface registered, for example, by their coordinates in space (e.g., in terms of GPS data). Alternatively, the points can correspond, for example, to times on a clock, or to the amount of completed timesteps of given length, or to a relative distance to some given point, or to absolute or relative locations of sensors. More generally, the points within the set of points describing the surface can correspond to elements of a list, where these elements may be of different types. In all cases, the points within the set of points describing the surface can either be determined beforehand, or they can be added to the, in the beginning possibly empty, set during the execution of the method, or a part of the points can be determined beforehand and another part can be added during the execution of the method, and/or the set of points describing the surface can be adapted in other ways during the execution of the method. Addition of points to and/or adaption of the set of points describing the surface can be implemented manually and/or automatically, e.g., according to a predefined plan, and/or depending on previous measurements and/or on the current set of points and/or on previous adaptions and/or on additional data. For points added during the execution of the method, their type may be according to a predefined plan, and/or depending on previous measurements and/or on the current set of points and/or on previous adaptions and/or on additional data, or may be chosen in each case or for a group of points.

A feature variable assigned to a point from the set of points describing the surface is determined based on a measurement data unit assigned to the same point. A measurement data unit is here a subset or the totality of the measurement data and the data contained in different measurement data units can overlap. The sequence of one or more software modules may be configured to generate a feature variable for every available measurement data unit, as soon as it is available or according to a predefined plan, and to assign this feature variable to the same point from the set of points describing the surface the measurement data unit is assigned to. Alternatively, the sequence of one or more software modules may be configured to generate a feature variable for every available point within the set of points describing the surface, as soon as it is available or according to a predefined plan, and to assign this feature variable to this point.

The mobile wheeled machine is mobile in the sense that it is not bound to a fixed location and can move freely on the ground/in space. In particular, the mobile wheeled machine is designed to be moved—as opposed to e.g., the surface, which can be immobile in the sense that it is not meant/designed to be moved, even though it might possibly be movable in principle.

Examples of embodiments of the mobile wheeled machine are a car or vehicle, a hand-held roll, a robot which moves by means of some number of wheels, a cart, a wheeled transportation system, a trolley, a roller, a skateboard. The mobile wheeled machine may be motorized or non-motorized.

The equipment of the mobile wheeled machine with the at least one measurement wheel can be realized by replacing a wheel of the mobile wheeled machine by the at least one measurement wheel and/or transforming a wheel of the mobile wheeled machine into the at least one measurement wheel and/or by attaching the at least one measurement wheel to the mobile wheeled machine in addition to its wheels. In all cases, the at least one measurement wheel is preferably arranged in such a way that some section of its outermost circumferential layer with respect to the axis of rotation is in contact with the surface most of the time.

Note that if a device A is equipped with a device B it is understood here that a reference to device A is a reference to device A together with device B. For example, if something refers to the mobile wheeled machine, it means that it refers to the mobile wheeled machine together with the at least one measurement wheel. Furthermore, if device A is equipped with device B, then the device A outside of device B is meant to correspond to device A without device B. For example, if something is arranged at the mobile wheeled machine outside of the at least one measurement wheel, it is arranged anywhere at the mobile wheeled machine except at the at least one measurement wheel.

The at least one measurement wheel can, for example, have the shape of a car or bike wheel, or the axial extension of its area of support compared to its diameter may be larger than that, in other words, its width compared to its height may be larger than it is the case for a car or bike wheel, as it is usually the case for e.g., rolls.

The at least one film-based sensor stripe is here preferably a long, thin stripe, and can have a thickness of up to several millimeters.

Thanks to the arrangement of the at least one film-based sensor stripe on the at least one measurement wheel one can receive measurement data no matter which circumferential section of the radially outermost layer of the at least one measurement wheel touches the ground respectively surface. Note that circling the measurement wheel with respect to the axis of rotation of the at least one measurement wheel does not necessarily imply that the at least one film-based sensor stripe has to form a closed loop; the stripe can also be arranged e.g., in a spiral manner.

The rubber layer preferably forms a layer of the at least one measurement wheel surrounding the axis of rotation of the at least one measurement wheel. More precisely, the rubber layer is preferably the outermost circumferential layer of the at least one measurement wheel with respect to its axis of rotation.

The rubber layer on the radially outer side of the at least one film-based sensor stripe protects the at least one film-based sensor stripe from environmental influences and can be mounted by overmolding the at least one film-based sensor stripe by the rubber layer.

As the mobile wheeled machine is mobile and the surface is immobile, driving the mobile wheeled machine over the surface means that the mobile wheeled machine is moved over the surface, e.g., like a car is moved over a street when one drives it on the latter. The process of driving may include intermediate stops.

In some cases, the movement sensing data gathered by the movement sensing device can be used to assign a measurement data unit, and therewith possibly the feature variable determined based on this measurement data unit, to a point from the set of points describing the surface. Such an assignment can be achieved on the computer hardware by coupling the received measurement data with the received movement sensing data in a predetermined manner by means of one or more modules of the sequence of one or more software modules. The coupling is realized, for example, by first assembling measurement data units and movement sensing data units according to some predefined rule and then writing possibly processed movement sensing data from the movement sensing data units into the metadata of allotted measurement data units. Here a movement sensing data unit is a subset of the movement sensing data and the data contained in different movement sensing data units can overlap. The assembling can for example be implemented by pairing up a measurement data unit with a movement sensing data unit according to some matching criterion. The matching criterion is for example that the receiving time of the data points or packages in the two units absolutely or on average does not differ more than a given amount, that the receiving time of the units does not differ more than a given amount, or that the data points or packages or units are equipped with matching tags. Here the equipment with tags can be realized by a software configured to write the tags into the metadata of the data points or packages or units and installed on the corresponding data acquisition devices or on one or more separate additional devices connected to the transmission line of the data, and a tag for example is a time and date stamp.

The measurement data and the movement sensing data can be gathered by the corresponding data acquisition devices during the whole execution of the method or during predefined periods and/or during periods chosen during the execution of the method.

The gathered measurement data and the gathered movement sensing data can be stored in a storage unit integrated in the mobile wheeled machine and/or be transmitted directly to the computer hardware. If data is stored in the storage unit integrated in the mobile wheeled machine, it may be transmitted at some predefined or triggered later time.

The gathered measurement data and the gathered movement sensing data can be transmitted to the computer hardware in real-time, i.e., the data is transmitted in the form of data points or predefined sets of data points as soon as those are available. Alternatively, the gathered measurement data and the gathered movement sensing data can be transmitted to the computer hardware at predefined times, or in predefined time intervals, or according to a predefined plan, or after all data is measured, or according to inputs during the execution of the method.

Similarly, the receiving of the transmitted measurement data and the transmitted movement sensing data on the computer hardware and/or the processing of the received measurement data and the received movement sensing data can be realized in real-time, i.e., as soon as the necessary data is available, or after all data is available, or according to a predefined plan, or to predefined times, or to predefined time intervals, or according to inputs during the execution of the method.

For the data transmission, the means for data transmission and the means for data reception can together form a wireless communication system, with a first wireless communication unit, connected to the at least one film-based sensor stripe and the movement sensing device, forming the means for data transmission, and a second wireless communication unit integrated in the computer hardware forming the means for data reception. Alternatively, or in combination, the means for data transmission and the means for data reception can together form separate or combined wired communication systems between the computer hardware and the at least one film-based sensor stripe and between the computer hardware and the movement sensing device.

The wireless communication units can consist of several subunits, for example senders and receivers. The connection between the wireless communication unit and the at least one film-based sensor stripe and the movement sensing device can be realised by wires.

Wired connections from the at least one measurement wheel to devices outside of the at least one measurement wheel can be realised by employing slip rings.

The sequence of one or more software modules can be just one program, or a sequence of programs where the output of one is automatically/manually fed into the next program. If the data transfer in between programs happens partly/fully automatically, we call the processing by means of the sequence of one or more software modules partly/fully automated. The computer hardware can be a computer or several computers or computing devices. The sequence of one or more software modules may include software installed on different devices.

Note that the steps (c), (d)(i) and (d)(ii) of the method can happen while the at least one measurement wheel is in motion and/or before and/or afterwards.

Further embodiments of the invention are set forth in the dependent claims.

In some embodiments of the method, the feature characteristics can be height characteristics, softness characteristics of the material of the surface, contact characteristics between the at least one measurement wheel and the surface, adherence characteristics of the at least one measurement wheel to the surface, friction characteristics, spatial 3D characteristics, material characteristics of the surface itself and/or of layers underneath the surface, locating characteristics of the presence of predefined substances on and/or in and/or underneath the surface, or preferably force characteristics, strain characteristics, or pressure characteristics.

Note that the above list of embodiments of the feature characteristics is not exhaustive. Furthermore, note that the preferred embodiments, i.e., the force characteristics, the strain characteristics, and the pressure characteristics, may be determined in an intermediate step in order to determine some of the other embodiments on the list or further embodiments not listed here.

If mathematically reasonable, several different feature characteristics can be determined in parallel or in sequence based on the same measurement data and possibly additional input which is possibly different for different feature characteristics. It is also possible to determine several different feature characteristics from measurement data corresponding to various measurement wheels and/or film-based sensor stripes in parallel. In any case, the determination of one feature characteristics corresponds to one execution of the method, whence every option of the method can be chosen independently for every feature characteristics. There may of course be restrictions regarding the choice of an option due to the choice of another option.

In some embodiments of the method, the at least one film-based sensor stripe can be printed-electronics-based and/or the at least one film-based sensor stripe can be electromechanical-based, and/or the at least one film-based sensor stripe (4) can measure resistive and/or capacitive quantities and/or a voltage, and/or the measurement of the at least one film-based sensor stripe (4) can correspond to a force and/or a strain and/or a pressure.

Printed-electronics-based film-based sensor stripes are usually particularly thin and particularly cheap to produce.

Electromechanical-based film-based sensor stripes are understood here as to involve the conversion of a mechanical input into an electrical signal. This conversion may be implemented in a purely mechanical way, or it can also employ other processes. Examples of such other processes are electrochemical processes and/or piezoelectrical processes and/or photoelectrical processes.

Alternatively, the at least one film-based sensor stripe may directly measure an environmental variable, like e.g., the temperature.

More examples of what the at least one film-based sensor stripe may measure are inductive quantities and/or a current.

The film-based sensor stripe can come without spatial resolution, i.e., such that one just receives one measurement value for the whole stripe. When integrated in the at least one measurement wheel, this measurement value ideally always corresponds to the part of the wheel in contact with the surface.

In some embodiments of the method, the movement sensing device can be a position sensor, preferably using Global Positioning System (GPS) technology, an acceleration sensor, a speed sensor, or an inertial measurement unit.

The movement sensing device can also be, for example, a sensor that senses the rotation of a wheel or the values of variables that describe the state of the mobile wheeled machine's engine, such as energy consumption or revolutions respectively steps per minute. Further examples include sensors that work with light emitters and/or receivers and image processing methods, and/or with ultrasound, and/or with induction.

The movement sensing device can be arranged at the at least one measurement wheel or at the mobile wheeled machine outside of the at least one measurement wheel. There can also be several movement sensing devices, possibly of different kind, and they can be arranged at the at least one measurement wheel, the mobile wheeled machine outside of the at least one measurement wheel, or at both, and if there are more than one measurement wheels the movement sensing devices can be arranged at a subset or at all of them and/or at the mobile wheeled machine outside of the measurement wheels.

In some embodiments of the method, the computer hardware can comprise at least one component integrated in the at least one measurement wheel and/or at least one component integrated in the mobile wheeled machine outside of the at least one measurement wheel and/or at least one component separated from the mobile wheeled machine.

Components of the computer hardware, as well as components of communication systems, which are integrated in the at least one measurement wheel can for example be embedded in the rubber layer, or, if the at least one measurement wheel comprises an inner backing layer, in a notch in the inner backing layer provided for this purpose or in a detachable or non-detachable manner at a freely accessible part of the inner backing layer.

Components of the computer hardware which are integrated in the mobile wheeled machine outside of the at least one measurement wheel can for example comprise or be part of an onboard computer of a vehicle or a robot, or be part of the handle of a hand-held device.

The movement sensing device can contain or be contained in components of the computer hardware.

The computer hardware can comprise readout electronics or components of the computer hardware can be contained in readout electronics.

Components of the computer hardware which are separated from the mobile wheeled machine can for example constitute individual devices not integrated in the mobile wheeled machine, like an external personal computer or an external server, or be part of an external device.

If the computer hardware comprises a part integrated in the at least one measurement wheel and a part integrated in the mobile wheeled machine outside of the at least one measurement wheel, and/or a part integrated in the at least one measurement wheel and a part separated from the mobile wheeled machine, and/or a part integrated in the mobile wheeled machine outside of the at least one measurement wheel and a part separated from the mobile wheeled machine, the connection between those parts can be realized by a wireless or wired communication system. In the case of a wired communication system, slip rings may be employed for the connection to possible parts integrated in the at least one measurement wheel.

In some embodiments of the method, the computer hardware can comprise a user interface unit for communicating information about the determined feature characteristics to a user.

The information which can be communicated to the user via the user interface comprises the information about the determined feature characteristics and possibly additional information.

The user interface unit may comprise a display on which information is presented to the user graphically and/or in text form. Alternatively, or in addition, the user interface unit may comprise a speaker for audible communication of information to the user and/or means to receive input and/or instructions from the user.

The possible instructions from the user comprise: the definition and/or adaption of the set of points describing the surface, when measurement data and/or movement sensing data should be captured and when and/or from where to where data should be transmitted.

In some embodiments of the method, the input of at least one of the modules of the sequence of one or more software modules can comprise one or more data from the set: date, time, orders to choose a specific feature for the feature characteristics to be determined, and data gathered by additional means for data collection.

The date and the time can, for example, correspond to an internal date and time of the computer hardware, or they can be automatically fetched by the computer hardware via an internet connection, or they can be provided as an input from the user via the user interface unit if the user interface unit is available.

The instructions to choose a specific feature for the feature characteristics to be determined can, for example, be provided as an input from the user via the user interface unit if the user interface unit is available, or they can be automatically generated, from the measurement data and/or other input and/or data, and provided by another module of the sequence of one or more software modules.

The data gathered by the additional means for data collection can be provided via a communication system for communication between the computer hardware and the additional means for data collection.

Any input data to any module of the sequence of one or more software modules may also be contained in the information communicated to the user via the user interface unit if the user interface unit is available.

If there are more than one mobile wheeled machine they may communicate with and provide input for each other. In addition, the mobile wheeled machine may communicate with machines of different kind and fetch input that way.

In some embodiments of the method, the additional means for data collection, can be part of the equipment of the mobile wheeled machine and can comprise at least one inertial measurement unit, preferably one inertial measurement unit arranged at the at least one measurement wheel and one inertial measurement unit arranged at the mobile wheeled machine outside of the at least one measurement wheel, and/or a temperature sensor, and/or a barometric pressure sensor, and/or a humidity sensor, and/or a gas sensor, preferably a CO2 sensor, and/or a liquid detection and/or analyzation sensor, and/or a photoelectrical sensor, and/or a light intensity sensor, and/or an ion sensor, and/or a vibration sensor, and/or an airflow sensor, and/or one or more motor sensors, and/or means for drive energy consumption sensing, and/or a position sensor, preferably using Global Positioning System (GPS) technology; and the mobile wheeled machine can also be equipped with means for transmitting data gathered by the additional means for data collection to the computer hardware in a manner compatible with the means for data reception.

The mobile wheeled machine could also be equipped with the listed additional means for data collection without the data gathered by those means being an input to modules of the sequence of one or more software modules but instead just being contained in the information communicated to the user via the user interface unit if the user interface unit is available and/or being used for further processing with other computing devices.

The listed additional means for data collection can be in several versions and each of them can be located at the at least one measurement wheel and/or at the mobile wheeled machine outside of the at least one measurement wheel.

There can also be additional means for data collection which are separated from the mobile wheeled machine.

Examples of data which can be gathered by the listed additional means for data collection comprise the acceleration of the mobile wheeled machine and/or the at least one measurement wheel, the speed of the mobile wheeled machine and/or the at least one measurement wheel, the angular velocity of the at least one measurement wheel, the angular position of the at least one measurement wheel, the temperature, the humidity, the barometric pressure, the charge rate and/or state of a battery, and the gas level in a tank.

In some embodiments of the method, the processing of the received measurement data and the received movement sensing data by means of the sequence of one or more software modules can be either fully or partly automated and/or at least one of the modules of the sequence of one or more software modules can comprise the step of postprocessing and/or noise handling of the measurement data, preferably employing signal conditioning methods.

The performance of most film-based sensors requires some postprocessing and/or noise handling of their measurement data.

The step of postprocessing and/or noise handling can, for example, be realized by employing known or new algorithms and/or sensor fusion. Here we mean by sensor fusion the process of combining sensor data and/or data gathered by additional means for data collection such that the resulting information has less uncertainty than would be possible when these sources were used individually.

If readout electronics are employed, they can comprise hardware means for postprocessing of the measurement data, for example low pass hardware filters. They can further comprise components of the computer hardware, or they may form part of the computer hardware. In both cases, at least one of the modules of the sequence of one or more software modules may be implemented on the readout electronics. This at least one module may orchestrate a signal conditioning method.

The signal conditioning method can be adaptive and/or real-time and/or it can employ a digital potentiometer.

The signal conditioning method can be a signal conditioning method for film-based sensor measurements orchestrated by a software module, wherein the software module is operatively connected to at least one film-based sensor and receives an auxiliary input signal; and where the software module is configured to orchestrate the following steps: a) setting a configuration G implementing an optimization goal to a predetermined a priori configuration G_0, and setting a signal conditioning parameter S to a predetermined initial value S_0; b) acquiring measurement data from the at least one film-based sensor and receiving the auxiliary input signal; c) updating S to S_1 based on the optimization goal implemented by the configuration G and the acquired measurement data; d) determining an updated configuration G_1 based at least on the acquired auxiliary data and subsequently setting G to G_1; e) repeating the steps b)-d) with index i of G_i replaced by index i+1 and index j of S_j replaced by j+1.

Here signal conditioning describes the manipulation of a measurement signal in such a way that it meets the requirements of the next stage for further processing. The latter requirements are here implemented by means of the configuration G describing the goal, whereas the manipulation is determined by the signal conditioning parameter S. For example, the at least one film-based sensor can be at least one electromechanical force sensor, which measures differences in the force applied by changes in resistance (force resistive sensor). The measurement of this effectively variable resistor (R_{var}) can be read out by means of a common voltage divider circuit employing a reference resistor (R_{ref}) and having as output analog voltage (V_{out}). More precisely, the voltage divider circuit consists of the variable resistor R_{var} and the reference resistor R_{ref} connected in series, where an input voltage V_{in} is applied across the resistor pair and the output voltage V_{out} emerging from the connection between them. The value of the variable resistor can then be computed from the known variables V_{in}, V_{out} and R_{ref} using the relation R_{var}=V_{out} *R_{ref}/(V_{in}-V_{out}). The analog voltage V_{out} can after measurement be processed by an analog digital converter (ADC), which usually has input ranges for which the output exhibits more or less linearity and input ranges for which the output exhibits more or less resolution. The goal can then for example be a high resolution or a broad range. This is implemented by the requirement for the measurement output V_{out} being in a certain range, which is then encoded in the configuration G. In order to modify the output V_{out} accordingly, the value of the reference resistor R_{ref} may be adapted. Here the value of the reference resistor R_{ref} can be determined via the signal conditioning parameter S, i.e., S_j can be the value the reference resistor R_{ref} is set to. The update of S therefore depends on the previously measured V_{out} and the optimization goal G. Here the reference resistor R_{ref} can be a digital potentiometer.

In some embodiments of the signal conditioning method for film-based sensor measurements orchestrated by a software module, the predetermined configuration G_0 can be either a predefined fixed mode or determined by the software module before initiation of the series of steps a)-e) using the auxiliary input signal.

In some embodiments of the signal conditioning method for film-based sensor measurements orchestrated by a software module, the software module can be configured to initiate the series of steps a)-e) when a predetermined condition C_I is met, where the predetermined condition C_I can be either a predefined fixed condition or determined by the software module before initiation of the series of steps a)-e) using the auxiliary input signal.

In some embodiments of the signal conditioning method for film-based sensor measurements orchestrated by a software module, the software module can be configured to terminate the repetition in step e) when a predetermined condition C_T is met, where the predetermined condition C_T can be either a predefined fixed condition or determined by the software module before initiation of the series of steps a)-e), and possibly updated during the execution of the series of steps a)-e), using the auxiliary input signal.

In some embodiments of the signal conditioning method for film-based sensor measurements orchestrated by a software module, the signal conditioning processed measurement data can be further processed by the software module and/or additional software during or after the execution of the method.

In some embodiments of the signal conditioning method for film-based sensor measurements orchestrated by a software module, the auxiliary input signal can be measurement data from one or more auxiliary data gathering devices, where the one or more auxiliary data gathering devices are one or more out of the list: position sensor, acceleration sensor, speed sensor, and at least one inertial measurement unit.

In some embodiments of the signal conditioning method for film-based sensor measurements orchestrated by a software module, the determination of the updated configuration G_i, i>0, can also be based on the measurement data from the at least one film-based sensor gathered in the present and possibly previous repetition round.

In some embodiments of the signal conditioning method for film-based sensor measurements orchestrated by a software module, the algorithm for the determination of the updated configuration G_i, i>0, can works with one or more of the principles: assignment of a set of parameters to a configuration according to predefined rules, e.g., depending on the ranges in which the values of the parameters fall, or changing the type of the configuration, e.g., according to a predefined plan, or until the measurement data satisfies predefined specifications.

In some embodiments of the signal conditioning method for film-based sensor measurements orchestrated by a software module, the configurations G_i, i>=0, can correspond to the optimization goals: maximum sensitivity, maximum range, or a specific range and/or sensitivity.

In some embodiments of the signal conditioning method for film-based sensor measurements orchestrated by a software module, the software module has different states, where the state implies restrictions on the possible configurations G_i, i>=0, and where the state can be set by a user via a user interface.

The signal conditioning method for film-based sensor measurements orchestrated by a software module in combination with at least one film-based sensor may be seen as a separate invention.

In some embodiments of the method, the determination of the feature characteristics can be performed in real-time.

This means that the feature variables are determined as soon as the necessary data are available.

In some embodiments of the method, at least one module of the sequence of one or more software modules can be configured to generate at least one instruction for the mobile wheeled machine from its input.

The input to the at least one module of the sequence of one or more software modules which is configured to generate at least one instruction for the mobile wheeled machine can be the feature variables, as soon as they are determined and available. The input can comprise additionally or alternatively data from the additional means for data collection if the additional means for data collection are available and/or user instructions via the user interface unit if the user interface unit is available and/or other data available on the computer hardware.

The instructions for the mobile wheeled machine can be generated in real-time, i.e., as soon the necessary input is available.

The instructions for the mobile wheeled machine can for example be communicated to the user via the user interface unit if the user interface unit is available or to a device controlling the mobile wheeled machine.

The instructions for the mobile wheeled machine can be, for example, to maintain a target speed or acceleration, or to change direction by a given angle or in a given target direction, or to go to a specific position.

The invention also relates to a measuring device for determining feature characteristics of a surface according to the method for determining feature characteristics of a surface, comprising a tubular inner backing layer, an outer rubber layer and at least one film-based sensor stripe arranged between the tubular inner backing layer and the outer rubber layer; wherein the measuring device can be removably attachable to a wheel or directly to a wheel axis such that the measuring device together with the wheel or the wheel axis it is attached to, forms one of the at least one measurement wheels.

The tubular inner backing layer may be made from various materials and it can be dimensionally stable or temporally or permanently deformable.

If the at least one measurement wheel comprises an inner backing layer, the at least one film-based sensor stripe can, for example, be attached to the inner backing layer using adhesive bonding on recessed surfaces, and/or the at least one film-based sensor stripe can be integrated in a sensor foil and the sensor foil is fixed to the inner backing layer with clips and/or pinch points and/or latching points and/or glue, where the glue has to be resistive to high temperature, and/or by lamination, i.e., by bonding the foil to the inner backing layer using heat and pressure, with or without the use of a bonding material.

The measuring device being removably attachable to the wheel or wheel axis has the advantage that if there is a problem with a sensor and/or the electronics, which are the most vulnerable parts of the whole measurement wheel, one can on the one hand easier check on it by detaching the measuring device from the wheel or the wheel axis, and on the other hand one can, if necessary, replace just the measuring device and not the whole wheel.

In some embodiments of the measuring device, the tubular inner backing layer can be either entirely made of polymer-based, preferably elastomer-based, material, or metal; or the tubular inner backing layer can be divisible into sections which are each made of polymer-based material or metal.

For example, the tubular inner backing layer can be a metallic structure with cavities filled with elastomer. The cavities filled with elastomer can be arranged such that they form the support of the at least one film-based sensor stripe.

The choice of material can for example influence the adherence of the at least one film-based sensor stripe to the tubular inner backing layer, the coupling of the latter to the wheel or wheel axis, and signals received by the at least one film-based sensor stripe. For example, the softness of the support of the at least one film-based sensor stripe influences the force transfer to the at least one film-based sensor stripe. Note that this force transfer is also influenced by the softness of the covering of the at least one film-based sensor stripe, i.e., by the softness of the rubber layer.

In some embodiments of the measuring device, the radially outer surface of the tubular inner backing layer can have either a uniform texture, preferably smooth or finned, or the radially outer surface of the tubular inner backing layer can be divisible into sections of different textures, each preferably smooth or finned.

By a finned texture is here also understood a corrugated, a serrated, or a waved texture.

An example of a finned texture is a finning with fins of the shape of triangular teeth. Such a texture induces vibration and therewith influences the signals received by the at least one film-based sensor stripe.

The texture can be functional, i.e., for example, it can enhance or decrease mechanical dampening and/or enhance or decrease adherence of the at least one film-based sensor stripe to the tubular inner backing layer and/or enhance or decrease how much different areas of the at least one film-based sensor stripe are exposed to external forces. Alternatively, or in addition, the texture can be non-functional, i.e., for example, a change in texture can allow to recognize the position and/or angle of the at least one measurement wheel.

In some embodiments of the measuring device, the tubular inner backing layer can comprise at least one connector for connecting the measuring device to the wheel or wheel axis.

In the case of the measuring device being meant to be attached to a wheel, the at least one connector is a fastener for fixing the measuring device to the wheel, e.g., in the form of a positioning rib. In the case of the measuring device being meant to be attached directly to a wheel axis, the at least one connector is a means for pivoting, i.e., rotatable mounting.

In some embodiments of the measuring device, the at least one film-based sensor stripe can be printed-electronics-based and/or the at least one film-based sensor stripe can be electromechanical-based, and/or the at least one film-based sensor stripe (4) can measure resistive and/or capacitive quantities and/or a voltage, and/or the measurement of the at least one film-based sensor stripe (4) can correspond to a force and/or a strain and/or a pressure.

It is understood that the measuring device for determining feature characteristics of a surface e.g., in the form of a sleeve for a wheel, may be seen as a separate invention independent of the method for determining feature characteristics of a surface.

### BRIEF EXPLANATION OF THE FIGURES

The invention is described in greater detail below with reference to embodiments that are illustrated in the figures. The figures show:

FIG. 1 a mobile wheeled machine on a surface communicating with a computer hardware.

FIG. 2a a section through a measuring device for forming a measurement wheel perpendicular to the axis of rotation of the wheel.

FIG. 2b a frontal view onto a measuring device for forming a measurement wheel, with the axis of rotation of the wheel being horizontal and with the outer rubber layer removed.

FIG. 3 feature characteristics and a graphical representation thereof. The matrix on the left shows coordinates (represented as a pair of numbers corresponding to the degree North and East in this reading order) in the first column and the corresponding force values (in Newtons) in the second column. In the graphic on the right, the x-axis is the sixth place after the comma of the decimal degree East and the y-axis is the second place after the comma of the number of Newtons.

### EMBODIMENTS OF THE INVENTION

### Embodiment 1

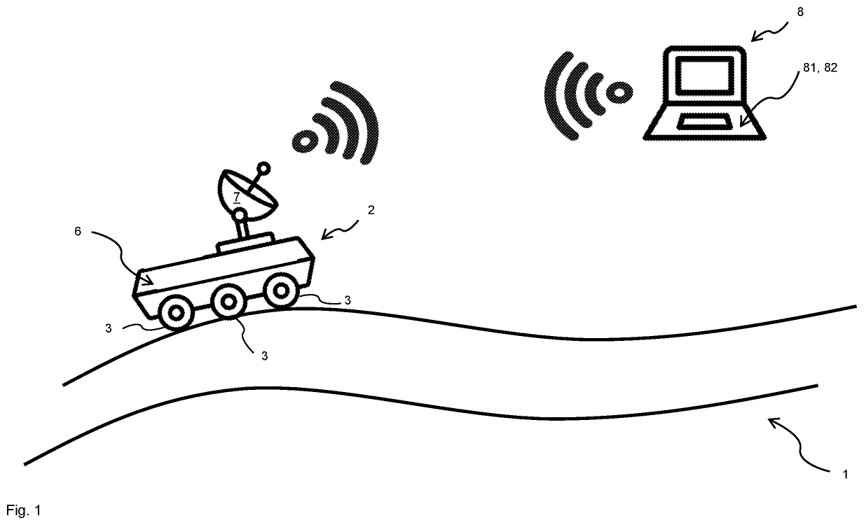

FIG. 1 shows a mobile wheeled machine 2, here in the form of a remotely controlled vehicle 2, which moves on the surface 1, which is here unknown terrain 1. The unknown terrain 1 could be not accessible and/or dangerous for human beings, e.g., the inside of a cave or a pipe, a war zone, or extra-terrestrial grounds.

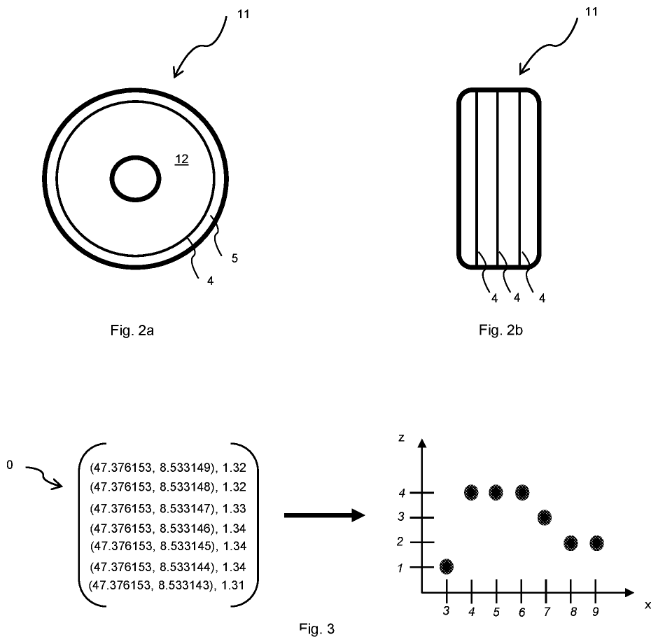

Here every wheel 3 of the vehicle 2 is a measurement wheel 3 comprising an axis and a measuring device 11 as shown in FIG. 2. The measuring device 11 shown in FIG. 2 comprises a tubular inner backing layer 12 made of metal and several electromechanical force sensor stripes 4 arranged on the tubular inner backing layer 12 in circles with respect to the axis of rotation of the wheel 3. These circles 4 are placed equidistantly on the wheel 3 and are covered by the rubber layer 5. The measuring device 11 can be attached to the axis to form the measurement wheel 3 by inserting the axis into the circular central recess of the measuring device 11 and then attaching clamps to the axis on both sides of the measuring device 11. Another way of attaching may be: create a sheath with the sensor stripes 4 and the rubber layer 5 and envelope the axis including the tubular inner backing layer 12 with this sheath.

The movement sensing device 6 is here a position sensor 6 using GPS. Accordingly, the movement sensing data is position data. The position sensor 6 is integrated in the vehicle 2 outside of its wheels 3.

The means for data transmission 7 are here a WLAN antenna 7. The antenna 7 is connected to the position sensor 6 via wires and to the sensors 4 via wires employing slip rings. The antenna 7 sends the measurement data and the position data to the computer hardware 8, which is here a laptop 8. The antenna 7 also receives instructions from the user via an app realizing the user interface as well as the signals allowing for the remote control, where the remote control is here implemented via the same app. The instructions and the remote-control orders are processed by an internal processor of the vehicle 2, which is not part of the computer hardware 8 and which is an intermediate station of the wirings between the sensors 4 and the antenna 7 and also of the wirings between the position sensor 6 and the antenna.

The vehicle 2 is equipped with additional means for data collection in the form of an inertial measurement unit for every wheel 3. The inertial measurement units are connected to the antenna 7 via wires and slip rings and the data gathered by the inertial measurement units is transmitted to the laptop 8 via WLAN similarly to the transmission of the measurement data.

To explore the unknown terrain 1, the vehicle 2 is driven by the user over the surface 1 and while driving, the sensors 4 measure changes in the force applied to the wheel surface.

The set of points describing the surface 1 are here GPS points on a grid, and a measurement by the sensors 4 and the inertial measurement units is performed whenever such a point on the grid is met. Here the interplay of the components of the vehicle 2 are orchestrated by the internal processor. The movement sensing data unit is here the GPS data of one grid point and the measurement data unit is here the number of Newtons describing the magnitude of the change in force measured by one sensor 4 for one GPS grid point. The internal processor writes the measurement date and time, according to its internal calendar and clock, of the GPS data unit into the metadata of the GPS data unit and the date and time, according to its internal calendar and clock, the measurement of the measurement data unit is triggered, into the metadata of the measurement data unit. Both data units including metadata are transmitted to the laptop 8 as soon as they are available and the laptop 8 receives the data via its integrated means for data reception in the form of a WLAN module 81.

The one or more software modules 82 correspond here to one program running on the laptop 8 comprising several modules with automated data handling among these modules. One of the modules, module A, determines for every measurement data unit the GPS grid point closest to the location where the corresponding measurement was performed, based on the GPS data unit with the date and time in the metadata being closest to the date and time in the metadata of the measurement data unit and the distance of the corresponding sensor part 4 from the antenna 7, which in a previous module B is determined from the arrangement of the corresponding sensor 4 on the wheel 3, the arrangement of the wheel 3 on the vehicle 2, and the data from the inertial measurement unit of the corresponding wheel 3. Module A then writes the GPS data of the identified closest GPS grid point into the metadata of the measurement data unit. Module C subsequently generates and determines for each measurement data unit a feature variable, here a force variable, which takes the value of the absolute force in Newtons computed from the measurement data in the measurement data unit and a given or previously established initial reference force, assigns to each feature variable the identified closest GPS grid point from the metadata of the corresponding measurement data unit and stores this couple into a list of such pairings. This list is the feature characteristics 0, in this case the force characteristics 0, as symbolically shown in FIG. 3.

A subsequent module D then generates a graphical representation of the force characteristics 0, where the GPS grid points span the x-y-plane and the z-axis is the magnitude of the force, i.e., the absolute force value, i.e., the determined feature variable, in units of Newtons. This graphical representation can then be accessed by the user via the app on the laptop 8 and the user therefore learns about the shape of the unknown terrain 1 and can also respond to obstacles like, e.g., avoid driving up steep hills in order to avoid unwanted turnovers of the vehicle 2.

### Embodiment 2

Alternative embodiments include the mobile wheeled machine 2 being a hand-held roll 2, comprising a roll 3 and a handle, which is driven on a line over a surface 1 by a person in order to e.g., flatten the surface 1.

The roll 3 without the handle is here the measurement wheel 3 and has several electromechanical pressure sensor stripes 4 arranged in rings around its axis of rotation and in equidistant relative spacing. These electromechanical pressure sensor stripes 4 measure signed changes in the pressure applied to the roll.

The computer hardware 8 is here a processor 8 integrated in the handle and the means for data transmission 7 and means for data reception 81 together form a wired connection employing slip rings. The movement sensing device 6 is an acceleration sensor 6 of an inertial measurement unit, where the inertial measurement unit is integrated in the roll 3 and is connected to the processor 8 by wires and slip rings.

The inertial measurement unit comprises a microprocessor orchestrating its actions and this microprocessor triggers a measurement of the acceleration sensor 6 every x microseconds, where 10<x<100. At the same points in time, the microprocessor of the inertial measurement unit also triggers a measurement of the electromechanical pressure sensor stripes 4 to which it is connected via wires. A movement sensing data unit is here the measurement result in meters per square second of one of the triggered measurements of the acceleration sensor 6 and a measurement data unit is the measurement result in Newtons per square meter of one of the triggered measurements of one of the electromechanical pressure sensor stripes 4.

Each data unit is sent to the processor 8 as soon as it is available.

The one or more software modules 82 correspond here to one program running on the tablet computer 8 comprising several modules with automated data handling among these modules. One of the modules, module a, writes into the metadata of every input data unit the date and time, according to the internal calendar and clock of the processor 8, when the input was fed to the program. Moreover, it writes into the metadata of the measurement data units the label of the corresponding electromechanical pressure sensor stripe 4. The corresponding electromechanical pressure sensor stripe 4 is assigned according to which wire delivered the measurement data unit.

The points within the set of points describing the surface 1 are here the labels of the electromechanical pressure sensor stripes 4.

Module b checks for every measurement time if the corresponding movement sensing data unit contains a non-zero value. If it contains no non-zero value, all measurement data units corresponding to the same measurement time, possibly up to some range of tolerance, are discarded. If it contains a non-zero value, then module b generates a feature variable, here a change of pressure variable, for every measurement data unit corresponding to the same, possibly up to some range of tolerance, measurement time and determines the value of the feature variable as being equal to the value constituting the data in the corresponding measurement data unit. Note that this value is not absolute but signed, i.e., equipped with a plus or minus sign. Subsequently, module b writes the feature values into a list in a fix ordering according to the labels of the sensors 4 in the metadata of their corresponding measurement data units. This list is the feature characteristics 0, which is here a pressure characteristics 0.

Subsequently, module c compares the list entries of the pressure characteristics 0 and if the entries corresponding to the electromechanical force sensor stripes 4 to the left of the handle in average are bigger respectively smaller than those to the right of the handle in average, it produces a signal which is transported over a wire to a red light-emitting diode on the left respectively right of the handle and causes the diode to light up. The person driving the hand-held roll 2 thus receives feedback in the form of lightened up red lamps on the right respectively on the left of the handle of the hand-held roll 2 whenever the pressure on the right respectively on the left end of the roll is increasing more than on the other side. The person therefore can respond by changing the force he or she applies to the handle.

Note that the embodiments of the different attributes of the method are not restricted to the possibilities mentioned above and neither are the possibilities for their combinations.

### REFERENCE SIGNS

0 Feature characteristics
1 Surface
2 Mobile wheeled machine
3 Measurement wheel
4 Film-based sensor stripe
5 Rubber layer
6 Movement sensing device
7 Means for data transmission
8 Computer hardware
81 Means for data reception
82 Sequence of one or more software modules
11 Measuring device
12 Tubular backing layer

1-16. (canceled)

17. A method for determining feature characteristics of a surface, the method comprising:
a) equipping a mobile wheeled machine with
i. at least one measurement wheel, where the at least one measurement wheel comprises at least one film-based sensor stripe which is arranged so that the at least one film-based sensor strip circles the at least one measurement wheel with respect to an axis of rotation of the at least one measurement wheel, and where the at least one film-based sensor stripe is covered by a rubber layer on a radially outer side of the at least one film-based sensor stripe,
ii. a movement sensing device, and
iii. means for data transmission from the at least one film-based sensor stripe and the movement sensing device;
b) driving the mobile wheeled machine over the surface;
c) transmitting measurement data measured by the at least one film-based sensor stripe and movement sensing data gathered by the movement sensing device to a computer hardware using the means for data transmission, where the computer hardware is equipped with means for data reception; and
d) on the computer hardware
i. receiving the transmitted measurement data and the transmitted movement sensing data using the means for data reception, and
ii. processing the received measurement data and the received movement sensing data by means of a sequence of one or more software modules installed on the computer hardware, where at least one module of the sequence of one or more software modules is configured to determine the feature characteristics from its input.

18. The method according to claim 17, wherein the feature characteristics include at least one of: height characteristics, softness characteristics of the material of the surface, contact characteristics between the at least one measurement wheel and the surface, adherence characteristics of the at least one measurement wheel to the surface, friction characteristics, spatial 3D characteristics, material characteristics of the surface and/or of layers underneath the surface, locating characteristics of the presence of predefined substances on and/or in and/or underneath the surface, force characteristics, strain characteristics, and pressure characteristics.

19. The method according to claim 17, wherein the at least one film-based sensor stripe is printed-electronics-based and/or the at least one film-based sensor stripe is electromechanical-based, and/or the at least one film-based sensor stripe measures resistive and/or capacitive quantities and/or a voltage, and/or the measurement of the at least one film-based sensor stripe corresponds to a force and/or a strain and/or a pressure.

20. The method according to claim 17, wherein the movement sensing device is a position sensor, an acceleration sensor, a speed sensor, or an inertial measurement unit.

21. The method according to claim 17, wherein the computer hardware comprises at least one component integrated in the at least one measurement wheel and/or at least one component integrated in the mobile wheeled machine outside of the at least one measurement wheel and/or at least one component separated from the mobile wheeled machine.

22. The method according to claim 17, wherein the computer hardware comprises a user interface unit for communicating information about the determined feature characteristics to a user.

23. The method according to claim 17, wherein the input of at least one of the modules of the sequence of one or more software modules comprises one or more data from the set: date, time, orders to choose a specific feature for the feature characteristics to be determined, and data gathered by additional means for data collection.

24. The method according to claim 23, wherein the additional means for data collection is part of the mobile wheeled machine and comprises at least one of an inertial measurement unit, a temperature sensor, a barometric pressure sensor, a humidity sensor, a gas sensor, a liquid detection and/or analyzation sensor, a photoelectrical sensor, a light intensity sensor, an ion sensor, a vibration sensor, an airflow sensor, one or more motor sensors, means for drive energy consumption sensing, and a position sensor; and
where the mobile wheeled machine is also equipped with means for transmitting data gathered by the additional means for data collection to the computer hardware in a manner compatible with the means for data reception.

25. The method according to claim 17, wherein the processing of the received measurement data and the received movement sensing data by means of the sequence of one or more software modules is either fully or partly automated and/or where at least one of the modules of the sequence of one or more software modules comprises the step of postprocessing and/or noise handling of the measurement data.

26. The method according to claim 17, wherein the determination of the feature characteristics is performed in real-time.

27. The method according to claim 17, wherein at least one module of the sequence of one or more software modules is configured to generate at least one instruction for the mobile wheeled machine from its input.

28. A measuring device for determining feature characteristics of a surface according to the method of claim 17, the measuring device comprising a tubular inner backing layer, an outer rubber layer and at least one film-based sensor stripe arranged between the tubular inner backing layer and the outer rubber layer;
wherein the measuring device is removably attachable to a wheel or directly to a wheel axis such that the measuring device together with the wheel or the wheel axis forms one of the at least one measurement wheels.

29. The measuring device according to claim 28, wherein the tubular inner backing layer is either entirely made of polymer-based material, or metal; or the tubular inner backing layer is divisible into sections which are each made of polymer-based material or metal.

30. The measuring device according to claim 28, wherein the radially outer surface of the tubular inner backing layer either has a uniform texture, or the radially outer surface of the tubular inner backing layer is divisible into sections of different textures.

31. The measuring device according to claim 28, wherein the tubular inner backing layer comprises at least one connector for connecting the measuring device to the wheel or wheel axis.

32. The measuring device according to claim 28, wherein the at least one film-based sensor stripe is printed-electronics-based and/or the at least one film-based sensor stripe is electromechanical-based, and/or the at least one film-based sensor stripe measures resistive and/or capacitive quantities and or a voltage, and or the measurement of the at least one film-based sensor stripe corresponds to a force and/or a strain and/or a pressure.
